(19) United States
(12) Patent Application Publication
(10) Pub. No.: US 2022/0192923 A1
(43) Pub. Date: Jun. 23, 2022

(54) RECONSTITUTION DEVICE AND METHOD OF RECONSTITUTION

(71) Applicant: Sanofi, Paris (FR)

(72) Inventors: Claus Geiger, Frankfurt am Main (DE); Sarah Helm, Frankfurt am Main (DE); Kerstin Traub-Hoffmann, Frankfurt am Main (DE); Till Bussemer, Frankfurt am Main (DE); Britta Furtmann, Frankfurt am Main (DE)

(21) Appl. No.: 17/438,301

(22) PCT Filed: Mar. 16, 2020
(86) PCT No.: PCT/EP2020/057025

§ 371 Date: Sep. 10, 2021

(30) Foreign Application Priority Data
Mar. 21, 2019 (EP) 19305347.7

(51) Int. Cl. A61J 1/16; A61J 1/20; B01F 29/10; B01F 35/22; B01F 35/42

(52) U.S. Cl. CPC A61J 1/16; A61J 1/2048; B01F 2101/22; B01F 35/22; B01F 35/42; B01F 29/10

(57) ABSTRACT

The present disclosure relates to a reconstitution device for reconstituting a medicament, the reconstitution device comprising: a base, a carrier movably arranged on the base, and a mount for a medicament container, wherein the mount is movably arranged on the carrier.

### CROSS REFERENCE TO RELATED APPLICATIONS

The present application is the national stage entry of International Patent Application No. PCT/EP2020/057025, filed on Mar. 16, 2020, and claims priority to Application No. EP 19305347.7, filed on Mar. 21, 2019, the entire disclosures of which are incorporated herein by reference.

### TECHNICAL FIELD

The present disclosure relates to a reconstitution device operable and configured to prepare, i.e. to reconstitute a liquid medicament. The disclosure further relates to a method of reconstituting a medicament

### BACKGROUND

Certain disease states require treatment using one or more different medicaments. Some drug compounds need to be delivered in a specific relationship with each other in order to deliver the optimum therapeutic dose. There are a number of potential problems when delivering two active medicaments or “agents” simultaneously. The two active agents may interact with each other during the long-term, shelf life storage of the drug formulation. Therefore, it is advantageous to store the active components separately and combine them at the point of delivery, e.g. injection, needle-less injection, pumps, or inhalation. Prior to or during injection the active components must be mixed appropriately.

Moreover, with some medicaments lyophilization of protein formulations is an essential tool for stabilization and is becoming increasingly important for pharmaceutical development. Reconstitution of a lyophilized pharmaceutical product, hence reconstitution of a so-called lyo cake is crucial to obtain an applicable pharmaceutical product. For a reconstitution of the medicament a liquid solvent or diluent is combined with the lyophilized product. This combination is then typically subject to a particular mechanical treatment, such as shaking, twisting, rolling or stirring until the drug has reconstituted or homogenized and the content of a respective medicament container becomes applicable for administering to a patient. Even though this step is influencing the quality of the final solution, it is so far a challenge to develop a standardized protocol as the mechanical treatment procedure is highly dependent on human factors of the operator.

### SUMMARY

It is desirable to provide an improved method of reconstitution and a device for reconstituting a medicament in a rather well-defined, reliable and safe way. The overall time required for reconstituting the medicament should be reduced and any potential deteriorating impact on the medicament should be avoided or at least reduced to a minimum.

In one aspect the disclosure relates to a reconstitution device operable and/or configured for reconstituting a medicament. The reconstitution device comprises a base and a carrier movably arranged on the base. The reconstitution device further comprises a mount for a medicament container. The mount is movably arranged on the carrier.

The reconstitution device is operable to provide a well-defined, highly reproducible mechanical treatment, e.g. movement of the medicament container when attached to or fixed to the mount. The mount and hence the medicament container attachable thereto is or are movable relative to the base with regard to a first degree of movement as defined by the movable arrangement of the carrier relative to the base. The mount and the medicament container are further movable with regard to a second degree of movement as defined by the movable arrangement of the mount on the carrier. The first and the second degrees of movement as defined by the movable carrier and as defined by the movable mount, respectively, may be different or may at least partially overlap.

In any way, since the mount is movable relative to the carrier and since the carrier is movable relative to the base, a rather complex but well-defined and highly reproducible movement of the medicament container relative to the base can be provided, which is beneficial for the reconstitution of the medicament inside the medicament container.

In particular, the movable arrangement of the carrier on the base may comprise a restricted or positively driven mechanical guidance. The same may be valid for the carrier movably arranged on the base.

With the present reconstitution device, the medicament container is movably arrangeable relative to the base in a twofold manner. A movement of the mount relative to the carrier may overlap with a movement of the carrier on the base. Accordingly, a first type of movement may overlap with or may be combined with a second type of movement, wherein the first type of movement of the medicament container is defined by the movable arrangement of the carrier on the base and wherein the second type of movement of the medicament container is defined by the movable arrangement of the mount relative to the carrier.

According to a further example, the carrier is rotationally mounted on the base. The carrier is rotatable relative to the base with regard to a first axis of rotation. The mount for the medicament container may be arranged at a predefined radial offset from the first axis of rotation on or at the carrier. In this way, the mount and/or the medicament container may be subject to a rotating motion relative to the base as the carrier is rotated relative to the base. This rotational movement may temporally or permanently overlap with the movement of the mount relative to the carrier while the carrier is subject to a rotation relative to the base.

With other examples, the mount is kept stationary on the carrier as the carrier is subject to a movement relative to the base. Here, numerous configurations are conceivable according to which the mount can be arranged at numerous or different positions on the carrier. With some examples, the mount may be fixable to at least one of numerous available positions on the carrier. In this way the position of the mount on the carrier can be modified. During a rotation or movement of the carrier relative to the base the mount can remain stationary relative to the carrier. The movable arrangement of the mount on the carrier thus enables and provides a reconfigurable arrangement, positioning and reconfigurable fastening of the mount on the movable carrier.

Instead of or in addition to the movable arrangement of the mount on the carrier the mount may simply be reconfigurably and/or detachably fixable to the carrier. Here, the mount may be detachable from one position of the carrier and may be attachable to another position on the carrier. When the carrier is for instance rotationally supported on the base, a radial distance of the mount to the first axis of rotation of the carrier can be modified. In this way, centrifugal forces present to the mount and hence applied to the medicament container while the carrier is subject to a rotation relative to the base can be modified.

According to another example the mount is rotationally mounted on the carrier and is rotatable relative to the carrier with regard to a second axis of rotation. Here, the mount itself is rotationally supported on the carrier. The first and second axes of rotation may extend parallel. The first and the second axis of rotation may extend at a predefined angle relative to each other. With some examples, the second axis of rotation extends at an angle that is substantially perpendicular to the direction of the first axis of rotation.

With the reconstitution device and during a reconstitution procedure performable with the reconstitution device at least one of the carrier and the mount is subject to a movement relative to the base. With numerous examples, both, the carrier and the mount are subject to a movement relative to the base simultaneously. Here, the carrier is subject to a movement relative to the base and at the same time the mount is subject to a movement relative to the carrier. In this way, at least two motions may overlap thus leading to a well-defined combined and rather complex motion of the mount relative to the base.

According to another example the carrier comprises a rotation stage. The rotation stage is rotationally mounted on the base and is rotatable relative to the base with regards to the first axis of rotation. The rotation stage may comprise a rotation table or a rotating disc rotationally supported with regards to the first axis of rotation.

According to a further example the mount is arranged or positioned on the rotation stage. The mount is fixable to the rotation stage. The mount is fixable on the rotation stage in at least a first and a second position, wherein the first position distinguishes from the second position by a radial distance from the first axis of rotation. Hence, the mount is attachable or arrangeable and fixable at numerous radial positions on the rotation stage. A radial distance or radial position of the mount on the rotation stage relative to the first axis of rotation can be modified.

According to a further example the mount is longitudinally displaceable on the carrier. For instance and when the carrier is rotationally supported on the base, the mount is longitudinally displaceable in radial direction with regard to the first axis of rotation. In this way, a radial distance between the mount and the first axis of rotation of the carrier can be modified. Centrifugal forces applicable to the medicament container and hence to the medicament located therein can be modified appropriately, simply by modifying the radial position of the mount on the carrier with respect to the first axis of rotation.

In a further example the reconstitution device comprises a first drive mechanically engaged with the carrier and configured to move the carrier relative to the base. Typically, the first drive comprises an electrical drive. The first drive is electrically operable to start and to stop the movement of the carrier. Optionally, the first drive is electrically operable to control, i.e. to vary or to modify a velocity of the movement of the carrier relative to the base. In particular, the first drive is controllable by a controller. The controller may be programmed so as to activate, to deactivate and/or to control the first drive in a well-defined and highly reproducible way.

According to a further example the reconstitution device comprises a second drive mechanically engaged with the mount and configured to move the mount relative to the base. The second drive is arranged on one of the mount and the carrier. The second drive is typically implemented as an electrical drive. The second drive is typically connected to a controller, e.g. the above mentioned programmable controller so as to start, to stop and/or to control movement and the velocity of the movement of the mount relative to the carrier.

The first drive and the second drive may be operable concurrently, alternatively or simultaneously by one and the same controller. Alternatively, there may be provided at least two separate controllers to control the first drive and the second drive separately. The first and the second drives enable or provide an electronically controllable movement of the mount relative to the carrier and/or relative to the base. In this way, a well-defined rotation, twisting, shaking, rolling or other mechanical motions of the medicament container relative to the base can be realized. In effect and as an advantage, the electronic control of at least one of the first and the second drives provides a rather automated, reliable and highly reproducible reconstitution process for the medicament provided inside the medicament container.

According to a further example the reconstitution device comprises a support that is arranged on the carrier. Moreover, at least one of the mount and the second drive is arranged on the support. In particular, it may be the support that is longitudinally displaceable on the carrier. The support may provide and/or define the second axis of rotation. The support may be detachably connected to numerous fastening positions on the carrier that are spatially separated from each other. The support forms a basis for the mount. It may provide a bearing for a rotational movement of the mount relative to the carrier.

With a further example the support is longitudinally displaceable relative to the carrier. Moreover, the support may be lockable to the carrier in one of numerous positional states on the carrier. At least one of the support and the carrier comprises mutually corresponding fastening elements by way of which the support can be locked to the carrier in any available positional state. In this way and when the carrier is implemented as a rotational stage a radial distance or radial position of the support and hence of the mount relative to the first axis of rotation can be modified on request.

With another example the reconstitution device comprises a first hinge connected to the base and connected to the carrier. The first hinge comprises a first hinge axis. The carrier is pivotable relative to the base with regard to the first hinge axis. The first hinge may comprise a first hinge arm that is pivotably connected to the base with regard to the first hinge axis. The first hinge arm may provide a support for the carrier. The carrier is typically mechanically connected to the first hinge arm. In particular, the carrier is moveably arranged on the first hinge arm. In other words, the carrier is mechanically connected to the base via the first hinge and via the first hinge arm. By pivoting the first hinge arm relative to the base, the orientation of the first axis of rotation can be modified.

According to a further example the reconstitution device comprises a second hinge connected to the mount and connected to the carrier. The second hinge comprises a second hinge axis. The mount is pivotable relative to the carrier with regard to the second hinge axis. The second hinge axis may comprise a second hinge arm that is pivotable relative to the carrier. With some examples the second hinge is supported or integrated into the support. Here, the second hinge arm may be connected to the mount whereas a further hinge component, such as a first hinge arm of the second hinge is connected to or integrated into the support. With the second hinge, the orientation of the second axis of rotation can be modified relative to the orientation of the carrier.

According to another example the first hinge axis extends at a non-zero angle with regard to the first axis of rotation. Typically, the first hinge axis and the first axis of rotation extend at a well-defined angle. The first hinge axis and the first axis of rotation may extend at an angle of about 90°.

With regard to the first axis of rotation the first hinge axis may extend tangentially. In this way and by pivoting the carrier with regard to the first hinge axis the orientation of the first axis of rotation can be modified relative to the base.

According to a further example the second hinge axis extends at a non-zero angle with regard to the second axis of rotation. Also here, the second hinge axis may extend at an angle of about 90° relative to the elongation of the second axis of rotation. Here, the second hinge axis may extend in radial direction or in tangential direction with regard to the second axis of rotation. With some examples, the second axis of rotation and the second hinge axis may intersect on or in one of the mount and the support.

The pivot point or pivot axis defined by the second axis of rotation may coincide with the second axis of rotation.

The same may also apply to the first hinge axis and the first axis of rotation. However, with some embodiments, the first hinge axis is located at a predefined radial distance from the first axis of rotation.

With some examples and/or with some configurations of the reconstitution device the first axis of rotation and the second axis of rotation extend parallel to each other. With some examples and/or with some configurations of the reconstitution device the first and the second hinge axis extend substantially parallel with regard to each other.

According to another example the reconstitution device comprises a controller that is operable to control a movement of the carrier relative to the base. Additionally or alternatively the controller is operable to control a movement of the mount relative to the carrier. The controller is typically connected to at least one of the first and the second drives. The controller may comprise a microcontroller operable to conduct a pre-programmed activation and deactivation of at least one of the first drive and the second drive. Moreover, the controller may be operable to control and/or to modify a velocity of at least one of the first drive and the second drive.

According to another example the reconstitution device comprises a clamping device to detachably fasten the medicament container on the mount. The clamping device may comprise at least one or two movable clamping elements to mechanically engage with the medicament container and to fasten the medicament container to the mount. The clamping device may comprise three equidistantly arranged clamping elements, one of which being movable, e.g. in radial direction with regard to a tubular-shaped geometry of the medicament container. Typically, at least the movable clamping element is operably engaged with a restoring element, such as a restoring spring operable to urge the clamping element against the medicament container so as to fix and/or to fasten the medicament container to the mount by way of clamping.

The second axis of rotation may extend through the mount. The mount may comprise a cylindrical geometry or cylindrical symmetry with the second axis of rotation as a symmetry axis. With some examples the numerous clamping elements of the mount are equidistantly arranged along an outer circumference of the tubular-shaped medicament container.

The mount and/or its numerous fastening elements is or are configured to fasten the medicament container in at least two different orientations or configurations on the mount. Typically, the medicament container comprises a planar-shaped bottom and a cylindrically-shaped sidewall. In one configuration, the medicament container is fastened or fixed to the mount with three fastening elements being engaged with the tubular-shaped sidewall of the medicament container. In a second and hence in a different configuration one of the fastening elements is engaged with a bottom of the medicament container whereas the residual, i.e. at least two further fastening elements are mechanically engaged with diametrically opposite sections of the sidewall of the medicament container. By arranging the medicament container in at least two different orientations or configurations on the mount, respective different and rather specific mechanical movements of the medicament container relative to the base can be provided in accordance to a reconstitution schedule or reconstitution procedure.

In a further example the reconstitution device is equipped with a medicament container. The medicament container is fastened to the mount. The medicament container may be fastened to the mount in one of at least two available fastening positions or fastening configurations. The medicament container is typically provided with a lyophilized drug or medicament. An interior space of the medicament container is at least partially occupied by the fireflies the drug, i.e. a lyo cake.

The medicament container is further configured to receive a diluent or solvent. The medicament container typically comprises at least one of an inlet or outlet sealed by a sealing cap. The sealing cap may comprise a pierceable septum allowing to supply at least one of a diluent and a solvent into the interior of the medicament container. The pierceable septum may comprise an elastomeric sealing disc or rubber stopper fixed to an outlet portion of the container. The pierceable septum can be fixed to an outlet portion of the container by a crimped metal cap, e.g. made of aluminum. The medicament container may comprise a barrel made of a substantially inert material, such as plastic or glass. The medicament container may comprise a sidewall that is transparent to at least one spectral range of electromagnetic radiation. The medicament container may be transparent. It may be made of a vitreous material. A transparent material of the medicament container allows a visual inspection of the medicament and in particular of the reconstituted medicament located inside the medicament container.

In another aspect the disclosure further relates to a method of reconstituting a medicament. The method comprises the steps of fastening of a medicament container to a mount of a reconstitution device as described above. The medicament container is please partially filled with a lyophilized medicament that requires reconstitution. Typically, at least a portion of the medicament container is occupied with a lyophilized drug or medicament.

Before or after fastening of the medicament container to the mount there will be added a solvent or diluent inside the medicament container that is required for the medicament reconstitution.

After the medicament container has been fastened to the mount, the carrier is moved relative to the base and/or the mount is moved relative to the carrier. Movement of at least one of the carrier and the mount is typically controlled by the controller and at least one of the first and second drive mechanically engaged with the carrier and with the mount, respectively.

Typically, the method of reconstituting is program controlled. The method is typically executed by a pre-programmed controller. The controller is operable to activate and/or to deactivate at least one of the first and second drives so as to move the medicament container relative to the base and/or relative to the carrier in a well-defined way over a predefined period of time.

The controller and hence the method may be implemented to execute a well-defined reconstitution program. The reconstitution program may comprise reconstitution-specific instructions according to which the mount for the medicament container has to be moved relative to the carrier and/or to the base at a first velocity over a first period of time. Thereafter, the program may define that the mount for the medicament container has to be moved in a different way. It may become subject to a second type of movement at a second velocity for a subsequent second period of time. During numerous method steps, the velocity and the type of movement may be subject to well-defined variations and/or modifications.

It should be further noted, that any features, modes of operation and benefits described above in connection with the reconstitution device equally apply to the method of reconstituting the medicament; and vice versa.

The term “drug” or “medicament”, as used herein, means a pharmaceutical formulation containing at least one pharmaceutically active compound,

wherein in one embodiment the pharmaceutically active compound has a molecular weight up to 1500 Da and/or is a peptide, a protein, a polysaccharide, a vaccine, a DNA, a RNA, an enzyme, an antibody or a fragment thereof, a hormone or an oligonucleotide, or a mixture of the above-mentioned pharmaceutically active compounds,

wherein in a further embodiment the pharmaceutically active compound is useful for the treatment and/or prophylaxis of diabetes mellitus or complications associated with diabetes mellitus such as diabetic retinopathy, thromboembolism disorders such as deep vein or pulmonary thromboembolism, acute coronary syndrome (ACS), angina, myocardial infarction, cancer, macular degeneration, inflammation, hay fever, atherosclerosis and/or rheumatoid arthritis,

wherein in a further embodiment the pharmaceutically active compound comprises at least one peptide for the treatment and/or prophylaxis of diabetes mellitus or complications associated with diabetes mellitus such as diabetic retinopathy,

wherein in a further embodiment the pharmaceutically active compound comprises at least one human insulin or a human insulin analogue or derivative, glucagon-like peptide (GLP-1) or an analogue or derivative thereof, or exendin-3 or exendin-4 or an analogue or derivative of exendin-3 or exendin-4.

Insulin analogues are for example Gly(A21), Arg(B31), Arg(B32) human insulin; Lys(B3), Glu(B29) human insulin; Lys(B28), Pro(B29) human insulin; Asp(B28) human insulin; human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Insulin derivates are for example B29-N-myristoyl-des(B30) human insulin; B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N-(N-palmitoyl-Y-glutamyl)-des(B30) human insulin; B29-N-(N-lithocholyl-Y-glutamyl)-des(B30) human insulin; B29-N-(w-carboxyheptadecanoyl)-des(B30) human insulin and B29-N-(ω-carboxyheptadecanoyl) human insulin.

Exendin-4 for example means Exendin-4(1-39), a peptide of the sequence H—His—Gly—Glu—Gly—Thr—Phe—Thr—Ser—Asp—Leu—Ser—Lys—Gln—Met—Glu—Glu—Glu—Ala—Val—Arg—Leu—Phe—Ile—Glu—Trp—Leu—Lys—Asn—Gly—Gly—Pro—Ser—Ser—Gly—Ala—Pro—Pro—Pro—Ser—NH2.

Exendin-4 derivatives are for example selected from the following list of compounds:

H-(Lys)4-des Pro36, des Pro37 Exendin-4(1-39)-NH2,

H-(Lys)5-des Pro36, des Pro37 Exendin-4(1-39)-NH2,

des Pro36 Exendin-4(1-39),

des Pro36 [Asp28] Exendin-4(1-39),

des Pro36 [IsoAsp28] Exendin-4(1-39),

des Pro36 [Met(O)14, Asp28] Exendin-4(1-39),

des Pro36 [Met(O)14, IsoAsp28] Exendin-4(1-39),

des Pro36 [Trp(O2)25, Asp28] Exendin-4(1-39),

des Pro36 [Trp(O2)25, IsoAsp28] Exendin-4(1-39),

des Pro36 [Met(O)14 Trp(O2)25, Asp28] Exendin-4(1-39),

des Pro36 [Met(O)14 Trp(O2)25, IsoAsp28] Exendin-4(1-39); or

des Pro36 [Asp28] Exendin-4(1-39),

des Pro36 [IsoAsp28] Exendin-4(1-39),

des Pro36 [Met(O)14, Asp28] Exendin-4(1-39),

des Pro36 [Met(O)14, IsoAsp28] Exendin-4(1-39),

des Pro36 [Trp(O2)25, Asp28] Exendin-4(1-39),

des Pro36 [Trp(O2)25, IsoAsp28] Exendin-4(1-39),

des Pro36 [Met(O)14 Trp(O2)25, Asp28] Exendin-4(1-39),

des Pro36 [Met(O)14 Trp(O2)25, IsoAsp28] Exendin-4(1-39),

wherein the group —Lys6-NH2 may be bound to the C-terminus of the Exendin-4 derivative;

or an Exendin-4 derivative of the sequence

des Pro36 Exendin-4(1-39)-Lys6-NH2 (AVE0010),

H-(Lys)6-des Pro36 [Asp28] Exendin-4(1-39)-Lys6-NH2,

des Asp28 Pro36, Pro37, Pro38Exendin-4(1-39)-NH2,

H-(Lys)6-des Pro36, Pro38 [Asp28] Exendin-4(1-39)-NH2,

H-Asn-(Glu)5des Pro36, Pro37, Pro38 [Asp28] Exendin-4(1-39)-NH2,

des Pro36, Pro37, Pro38 [Asp28] Exendin-4(1-39)-(Lys)6-NH2,

H-(Lys)6-des Pro36, Pro37, Pro38 [Asp28] Exendin-4(1-39)-(Lys)6-NH2,

H-Asn-(Glu)5-des Pro36, Pro37, Pro38 [Asp28] Exendin-4(1-39)-(Lys)6-NH2,

H-(Lys)6-des Pro36 [Trp(O2)25, Asp28] Exendin-4(1-39)-Lys6-NH2,

H-des Asp28 Pro36, Pro37, Pro38 [Trp(O2)25] Exendin-4(1-39)-NH2,

H-(Lys)6-des Pro36, Pro37, Pro38 [Trp(O2)25, Asp28] Exendin-4(1-39)-NH2,

H-Asn-(Glu)5-des Pro36, Pro37, Pro38 [Trp(O2)25, Asp28] Exendin-4(1-39)-NH2,

des Pro36, Pro37, Pro38 [Trp(O2)25, Asp28] Exendin-4(1-39)-(Lys)6-NH2,

H-(Lys)6-des Pro36, Pro37, Pro38 [Trp(O2)25, Asp28] Exendin-4(1-39)-(Lys)6-NH2,

H-Asn-(Glu)5-des Pro36, Pro37, Pro38 [Trp(O2)25, Asp28] Exendin-4(1-39)-(Lys)6-NH2,

H-(Lys)6-des Pro36 [Met(O)14, Asp28] Exendin-4(1-39)-Lys6-NH2,

des Met(O)14 Asp28 Pro36, Pro37, Pro38 Exendin-4(1-39)-NH2,

H-(Lys)6-desPro36, Pro37, Pro38 [Met(O)14, Asp28] Exendin-4(1-39)-NH2,

H-Asn-(Glu)5-des Pro36, Pro37, Pro38 [Met(O)14, Asp28] Exendin-4(1-39)-NH2,

des Pro36, Pro37, Pro38 [Met(O)14, Asp28] Exendin-4(1-39)-(Lys)6-NH2,

H-(Lys)6-des Pro36, Pro37, Pro38 [Met(O)14, Asp28] Exendin-4(1-39)-(Lys)6-NH2,

H-Asn-(Glu)5 des Pro36, Pro37, Pro38 [Met(O)14, Asp28] Exendin-4(1-39)-(Lys)6-NH2,

H-Lys6-des Pro36 [Met(O)14, Trp(O2)25, Asp28] Exendin-4(1-39)-Lys6-NH2,

H-des Asp28 Pro36, Pro37, Pro38 [Met(O)14, Trp(O2)25] Exendin-4(1-39)-NH2,

H-(Lys)6-des Pro36, Pro37, Pro38 [Met(O)14, Asp28] Exendin-4(1-39)-NH2,

H-Asn-(Glu)5-des Pro36, Pro37, Pro38 [Met(O)14, Trp(O2)25, Asp28] Exendin-4(1-39)-NH2,

des Pro36, Pro37, Pro38 [Met(O)14, Trp(O2)25, Asp28] Exendin-4(1-39)-(Lys)6-NH2,

H-(Lys)6-des Pro36, Pro37, Pro38 [Met(O)14, Trp(O2)25, Asp28] Exendin-4(S1-39)-(Lys)6-NH2,

H-Asn-(Glu)5-des Pro36, Pro37, Pro38 [Met(O)14, Trp(O2)25, Asp28] Exendin-4(1-39)-(Lys)6-NH2;

or a pharmaceutically acceptable salt or solvate of any one of the afore-mentioned Exendin-4 derivative.

Hormones are for example hypophysis hormones or hypothalamus hormones or regulatory active peptides and their antagonists as listed in Rote Liste, ed. 2008, Chapter 50, such as Gonadotropin (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, Goserelin.

A polysaccharide is for example a glucosaminoglycane, a hyaluronic acid, a heparin, a low molecular weight heparin or an ultra low molecular weight heparin or a derivative thereof, or a sulphated, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium.

Antibodies are globular plasma proteins (˜150 kDa) that are also known as immunoglobulins which share a basic structure. As they have sugar chains added to amino acid residues, they are glycoproteins. The basic functional unit of each antibody is an immunoglobulin (Ig) monomer (containing only one Ig unit); secreted antibodies can also be dimeric with two Ig units as with IgA, tetrameric with four Ig units like teleost fish IgM, or pentameric with five Ig units, like mammalian IgM.

The Ig monomer is a “Y”-shaped molecule that consists of four polypeptide chains; two identical heavy chains and two identical light chains connected by disulfide bonds between cysteine residues. Each heavy chain is about 440 amino acids long; each light chain is about 220 amino acids long. Heavy and light chains each contain intrachain disulfide bonds which stabilize their folding. Each chain is composed of structural domains called Ig domains. These domains contain about 70-110 amino acids and are classified into different categories (for example, variable or V, and constant or C) according to their size and function. They have a characteristic immunoglobulin fold in which two β sheets create a “sandwich” shape, held together by interactions between conserved cysteines and other charged amino acids.

There are five types of mammalian Ig heavy chain denoted by α, δ, ε, γ, and μ. The type of heavy chain present defines the isotype of antibody; these chains are found in IgA, IgD, IgE, IgG, and IgM antibodies, respectively.

Distinct heavy chains differ in size and composition; α and δ contain approximately 450 amino acids and δ approximately 500 amino acids, while μ and ε have approximately 550 amino acids. Each heavy chain has two regions, the constant region (C_{H}) and the variable region (V_{H}). In one species, the constant region is essentially identical in all antibodies of the same isotype, but differs in antibodies of different isotypes. Heavy chains γ, α and δ have a constant region composed of three tandem Ig domains, and a hinge region for added flexibility; heavy chains μ and ε have a constant region composed of four immunoglobulin domains. The variable region of the heavy chain differs in antibodies produced by different B cells, but is the same for all antibodies produced by a single B cell or B cell clone. The variable region of each heavy chain is approximately 110 amino acids long and is composed of a single Ig domain.

In mammals, there are two types of immunoglobulin light chain denoted by λ and κ. A light chain has two successive domains: one constant domain (CL) and one variable domain (VL). The approximate length of a light chain is 211 to 217 amino acids. Each antibody contains two light chains that are always identical; only one type of light chain, κ or λ, is present per antibody in mammals.

Although the general structure of all antibodies is very similar, the unique property of a given antibody is determined by the variable (V) regions, as detailed above. More specifically, variable loops, three each the light (VL) and three on the heavy (VH) chain, are responsible for binding to the antigen, i.e. for its antigen specificity. These loops are referred to as the Complementarity Determining Regions (CDRs). Because CDRs from both VH and VL domains contribute to the antigen-binding site, it is the combination of the heavy and the light chains, and not either alone, that determines the final antigen specificity.

An “antibody fragment” contains at least one antigen binding fragment as defined above, and exhibits essentially the same function and specificity as the complete antibody of which the fragment is derived from. Limited proteolytic digestion with papain cleaves the Ig prototype into three fragments. Two identical amino terminal fragments, each containing one entire L chain and about half an H chain, are the antigen binding fragments (Fab). The third fragment, similar in size but containing the carboxyl terminal half of both heavy chains with their interchain disulfide bond, is the crystallizable fragment (Fc). The Fc contains carbohydrates, complement-binding, and FcR-binding sites. Limited pepsin digestion yields a single F(ab′)2 fragment containing both Fab pieces and the hinge region, including the H-H interchain disulfide bond. F(ab′)2 is divalent for antigen binding. The disulfide bond of F(ab′)2 may be cleaved in order to obtain Fab′. Moreover, the variable regions of the heavy and light chains can be fused together to form a single chain variable fragment (scFv).

Pharmaceutically acceptable salts are for example acid addition salts and basic salts. Acid addition salts are e.g. HCl or HBr salts. Basic salts are e.g. salts having a cation selected from alkali or alkaline, e.g. Na+, or K+, or Ca2+, or an ammonium ion N+(R1)(R2)(R3)(R4), wherein R1 to R4 independently of each other mean: hydrogen, an optionally substituted C1-C6-alkyl group, an optionally substituted C2-C6-alkenyl group, an optionally substituted C6-C10-aryl group, or an optionally substituted C6-C10-heteroaryl group. Further examples of pharmaceutically acceptable salts are described in “Remington's Pharmaceutical Sciences” 17. ed. Alfonso R. Gennaro (Ed.), Mark Publishing Company, Easton, Pa., U.S.A., 1985 and in Encyclopedia of Pharmaceutical Technology.

Pharmaceutically acceptable solvates are, for example, hydrates.

It will be further apparent to those skilled in the art that various modifications and variations can be made to the present disclosure without departing from the scope of the disclosure. Further, it is to be noted, that any reference numerals used in the appended claims are not to be construed as limiting the scope of the disclosure.

### BRIEF DESCRIPTION OF THE FIGURES

In the following, numerous examples of the container and of an injection device will be described in greater detail by making reference to the drawings, in which:

FIG. 1 shows an example of a reconstitution device;

FIG. 2 shows the reconstitution device of FIG. 1 in another perspective with a housing at least partially removed;

FIG. 3 shows a cross-section through the reconstitution device of FIGS. 1 and 2;

FIG. 4 shows the reconstitution device of FIG. 1 in a further configuration;

FIG. 5 shows the reconstitution device of FIG. 1 in another configuration;

FIG. 6 represents a flowchart of the method of operating the reconstitution device;

FIG. 7 shows the mount of the reconstitution device in greater detail;

FIG. 8 is a cross-section through the mount according to FIG. 7;

FIG. 9 is another perspective view of the mount in a radial position on the carrier; and

FIG. 10 is a further perspective view of the mount in another radial position on the carrier.

### DETAILED DESCRIPTION

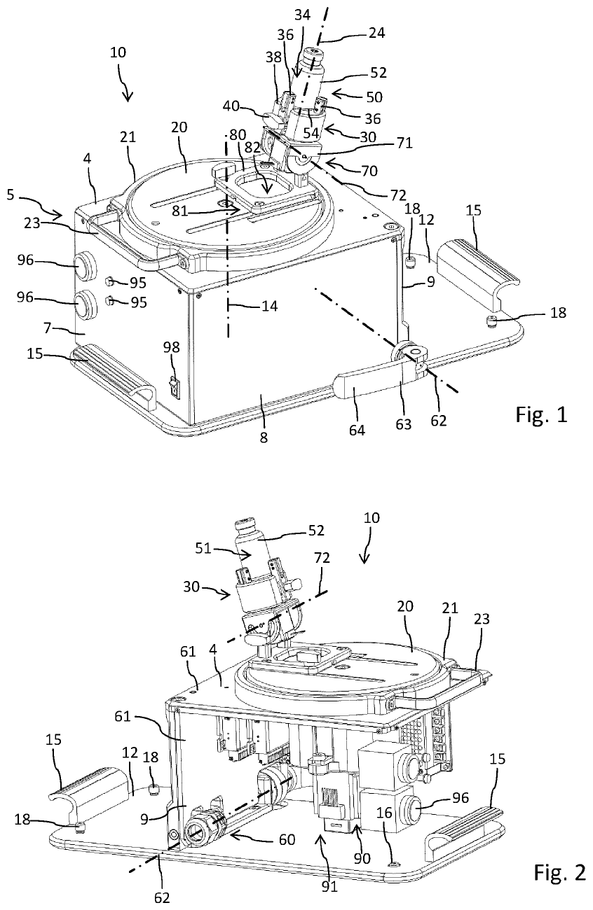

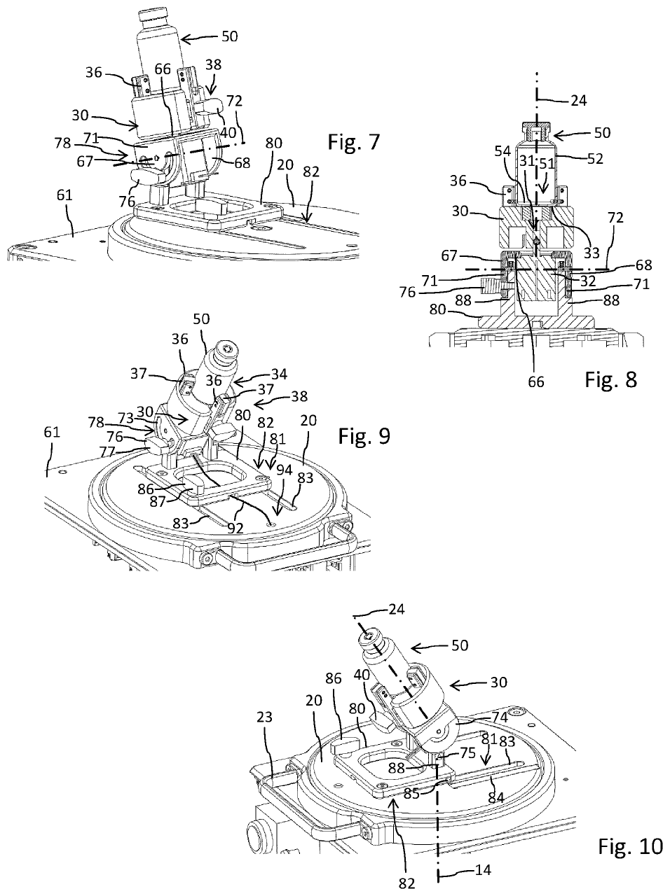

In FIGS. 1-5 and in FIGS. 7-10, numerous configurations of an example of a reconstitution device 10 are illustrated. The reconstitution device 10 comprises a base 12. The base 12 can be stationary located on a tabletop or on any other kind of support, such as a floor section inside a building. The reconstitution device 10 further comprises a carrier 20. The carrier 20 is movably arranged on the base 12. In the presently illustrated example the carrier 20 is rotationally mounted on the base 12. It is rotational relative to the base 12 with regard to a first axis of rotation 14. Insofar the carrier 20 may comprise a rotational stage that is rotational relative to the base 12 with regard to the first axis of rotation 14.

On the carrier 20 there is movably arranged a mount 30 for a medicament container 50. Typically, the medicament container 50 is at least partially filled with a medicament 51. The medicament 51 typically comprises a lyophilized drug or lyophilized pharmaceutical product. For reconstituting the medicament there may be provided a diluent or solvent inside the medicament container 50. The diluent or solvent may be added to the medicament 51 inside the medicament container 50 before or after the medicament container 50 is mounted, e.g. fixed or fastened to the mount 30.

As illustrated in FIGS. 1 and 9, the mount 30 may be provided with a fastening device or clamping device 34 in order to detachably fasten the medicament container 50 to the mount 30.

The mount 30 is movably arranged on the carrier 20. As it is apparent from a comparison of FIGS. 9 and 10 the mount 30 can be arranged and fastened to the carrier 20 at least in two different positions. For this, the mount 30 is provided with a support 80. The support 80 is lockable to the carrier 20 in numerous positional states on the carrier 20. In the configuration as illustrated in FIG. 10, the support 80 is arranged fairly close to the first axis of rotation 14. In the configuration of FIG. 9, the support 80 and hence the mount 30 for the medicament container 50 is arranged at a radial distance from the first axis of rotation 14 that is larger than the respective radial distance as illustrated in FIG. 9. Accordingly, and by means of the support 80 the mount 30 can be positioned and fixed to numerous positional states on the carrier 20. In this way and with a rotatable carrier 20 the radial distance of a radial position of the mount 30 with regard to the first axis of rotation 14 can be modified.

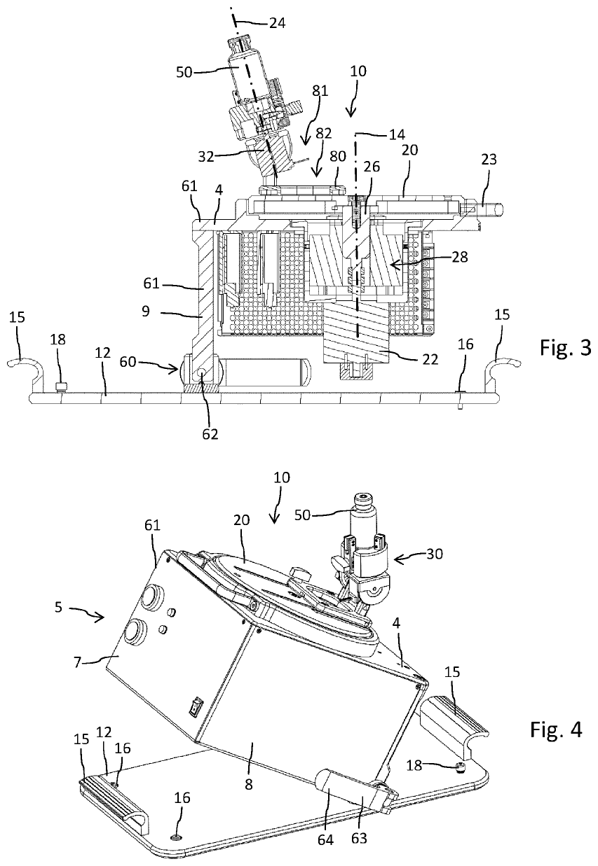

The carrier 20 is rotationally supported on the base 12. As illustrated in FIG. 3, the carrier 20 is rotationally locked to a shaft 26 that is rotationally supported on the base 12. The shaft 26 is in a torque transmitting engagement with a drive 22. The drive 22 is implemented as an electrical drive. The drive 22 is controllable by a controller 90. The drive 22 and the shaft 26 are mechanically engaged through a gearbox 28 fastened to the base 12. With other examples, the shaft 26 can be directly rotationally engaged with a drive side or output of the drive 22.

In either way and by activating of the drive 22 the carrier 20 can be set in a rotational movement relative to the base 12 with regard to the first axis of rotation 14. The drive 22 is mounted on the base 12. The drive 22 and the gearbox 28 may be pivot mounted on the base 12. By activating the drive 22 and by rotating the carrier 20 with regard to the first axis of rotation 14 a shaking-imitating motion of the mount 30 and of the medicament container 50 attached thereto can be realized.

The reconstitution device 10 may further comprise a housing 5. The housing 5 may be of rectangular or cubic shaped. The housing 5 as illustrated in FIGS. 1-5 comprises a top 4, two oppositely located sidewalls 8, a bottom 6 opposite to the top 4, a front wall 7 and a back wall 9. The back wall 9 is located opposite to the front wall 7.

The housing 5 can be displaceable mounted, e.g. pivot mounted on the base 12. There may be provided a first hinge 60 by way of which the housing 5 in its entirety can be pivoted with regard to a first hinge axis 62 relative to the base 12. The base 12 typically comprises a planar-shaped base plate. There may be provided a first handle 15 attached or affixed to one end of the base 12. They may be provided a further, i.e. a second handle 15 also attached or fixed to the base 12. The two handles 15 may be located at opposite ends of the base 12. By means of the handles 15 and the base 12 the entire reconstitution device 10 can be easily carried from one place to another place.

For a secure and steadfast mounting of the reconstitution device 10, e.g. on a table, there may be provided at least one fastener 16 extending through the base 12 or through the respective base plate. By means of the fastener 16 the base 12 can be non-movably fastened to a support, e.g. to a table. The fastener 16 may comprise a fastening screw.

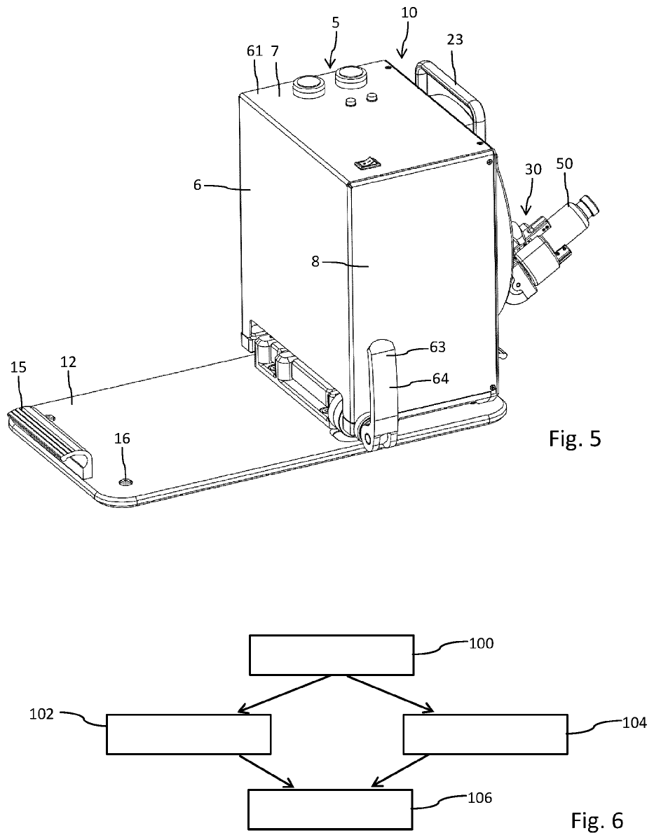

The housing 5 is pivot mounted on the base 12 with regard to a first hinge axis 62. The first hinge axis 62 may substantially coincide with a corner section of the back wall 9 and the bottom 6 of the housing 5. At a predefined distance from the back wall 9 and outside the housing 5 there may be provided at least one stop 18 on an upper side of the base 12. The at least one stop 18 may protrude from the base 12. The at least one stop 18 provides a well-defined stop for a pivoting motion of the housing 5 relative to the first hinge axis 62. In the configuration as illustrated in FIG. 5, in which the housing 5 has been rotated by 90° with regard to the first hinge axis 62 the back wall 9 gets in abutment with the at least one stop 18. There may be provided numerous, at least two stops 18 on the base 12 to provide at least a twofold abutment of the back wall 9 when the housing 5 is flipped or pivoted into a configuration as illustrated in FIG. 5. Here, the first axis of rotation 14 extends substantially parallel to the plane of the base 12.

On the opposite front wall 7 there are provided numerous control elements 96, 98. By means of the control element 98, the entire reconstitution device 10 can be switched on and off. The control elements 96 may serve to start and/or to stop a motion of at least one of the carrier 20 and the mount 30. For instance, one of the control elements 96 is operable to control a rotary motion of the carrier 20 wherein the other control element 96 is operable to control the rotary motion of the mount 30. For each one of the control elements 96 there may be provided a visual indicator 95 thus indicating whether the carrier 20 or the mount 30 is in motion or not.

There is further provided a fastener 63 by way of which a pivoting motion of the housing 5 and/or of a first hinge arm 61 of the hinge 60 can be fixed or impeded. The fastener 63 may comprise a cam lever 64 allowing to fix or to release a pivot motion of the first hinge 16. In this way also an inclined position of the housing 5 between an initial configuration as illustrated in FIG. 1 and an upright configuration as illustrated in FIG. 5 can be obtained and/or maintained. In such a tilted or inclined orientation of the housing 5 and/or of the hinge arm 61 the housing 5 can be fastened and/or fixed relative to the base 12.

As it is further illustrated in FIG. 1 the carrier 20 comprises a rotating table located on top of the housing 5. The carrier 20 may comprise a circular shape. It is surrounded and confined in radial direction by a frame 21. The frame 21 and the carrier 20 have substantially the same axial height or thickness with regard to the first axis of rotation 14. The frame 21 is non-movably fixed to the top 4 and hence to the first hinge arm 61. In particular, the first hinge arm 61 and the back wall 9 can be integrally formed. The non-movable frame 21 provides a protection for the movable carrier 20. By the surrounding frame 21 the movable part of the carrier 20 becomes substantially inaccessible from outside.

As illustrated in FIGS. 1 and 5, there is further provided a handle 23 on the top 4 of the housing 5. The handle 23 or handle bar extends beyond the front wall 7. It may be attached to or integrally formed with the frame 21. The handle 23 can be easily gripped by a user to induce a pivoting motion of the housing 5 and/or of the hinge arm 61.e.g. to transfer the reconstitution device 10 from a configuration as illustrated in FIG. 1 towards a configuration as illustrated in FIG. 5; and vice versa.

On an upper side of the carrier 20 facing away from the base 12 the support 80 is displaceably mounted in radial direction with respect to the first axis of rotation 14. There may be provided a sliding mechanism 82 by way of which the support 80 is slidably displaceable on the carrier 80 at least with regard to the radial direction. In this way, the radial position of the support 80 and of the mount 30 with regard to the first axis of rotation can be modified in a way as desired by, e.g. a predefined reconstitution protocol.

The support 80 is movably connected to the carrier 20 through at least one slotted link 81. The slotted link 81 comprises at least one elongated and straight shaped groove 83. The groove 83 may be provided on top of the carrier 20. The support 80 comprises a correspondingly shaped pin slidably guided in the groove 83. With other embodiments, the support 80 is provided with an elongated groove and the carrier 20 comprises a correspondingly shaped pin slidably engaged with the groove of the support 80.

As illustrated in FIGS. 7 to 10 the support 80 comprises a kind of a sliding carrier that is slidably displaceable along the elongation of the groove 83. In the illustrated example, there are provided two parallel grooves to restrict the movement of the support 80 relative to the carrier 20 in radial direction with regards to the first axis of rotation 14 and hence along the elongation of the grooves 83.

There is further provided a fastener 86 on at least one of the carrier 20 and the support 80. By way of the fastener 86 the support 80 can be fixed in any available positional state of the carrier 20. By means of the slotted link 81 the support 80 can be moved continuously and/or steplessly along the groove(s) 83 on top of the carrier 20.

As further illustrated in FIG. 10, there is provided at least one scale 84 extending along at least one of the grooves 83 on the carrier 20. On the support 80 there is provided an indicator 85 directly adjacent to the scale 84 and pointing onto or towards the scale 84. The scale 84 may be provided with numerous symbols, numbers similar indications, thus allowing to determine the position of the support 80 along the slotted link 81. In this way, the position of the support 80 on the carrier 20 can be precisely reproduced. Any available positional state of the support 80 on the carrier 20 can be characterized by the position of the indicator 85 relative to the scale 84.

In addition or alternative to the sliding mechanism 82 the mount 30 can also be rotationally supported on the carrier 20 with regard to a second axis of rotation 24. The second axis of rotation 24 can be defined by the support 80 or by any other bearing structure by way of which the mount 30 is fastened or fixed to the carrier 20. In the configuration as illustrated in FIGS. 1 through 3, the second axis of rotation 24 extends tilted or inclined to the first axis of rotation 14. The second axis of rotation 24 may substantially coincide with a symmetry axis of the mount 30 and hence with a symmetry axis of an, e.g. tubular-shaped medicament container 50 that is fastenable to the mount 30. The mount 30 can be rotationally supported on the carrier 20 and in particular on the support 80 by means of a second drive 32. For this, the support 80 comprises a rotary bearing 31 by way of which the mount 30 is rotationally supported on the support 80 and hence on the carrier 20.

The second drive 32 is typically implemented as an electrical drive. It is operable and/or controllable by the controller 90. The first drive 22 and the second drive 32 may be controllable by one and the same controller 90. With some examples, the first drive 22 may be coupled with a first controller 90. The second drive 32 may be coupled with a second controller separate from the first controller 90. Hence, they may be provided at least two independent controllers for each one of the first and second drives 22, 32, respectively. A wire 92 that may electrically connect the second drive 32 and the controller 90 extends through the hollow shaft 26. There may be provided a rotation-invariant cable bushing 94 on or through the hollow shaft 26. In addition or instead of a wire or cable connection there may also be provided sliding contacts between the controller 90 and at least one of the drives 22, 32. With a sliding contact a rotation-invariant electrical connection can be provided at least between the controller 90 and the second drive 32. The sliding contact may be provided by one or several hollow slip rings. The controller 90 may be further equipped with an interface 91, enabling data transmission to and from the controller 90. In this way, the controller 90 can be pre-programmed in accordance to a pre-defined reconstitution protocol.

With the first and the second axis of rotation 14, 24 and with first and second separate drives 22, 32 a combined rotating and circular motion of the mount 30 and hence of the medicament container 50 can be provided. By means of the second drive 32 and the respective rotational bearing of the mount 30 on the support 80 the medicament container 50 may rotate around its symmetry axis. By means of the first drive 22, a kind of a stirring motion can be implemented. The rotation directions of the mount 30 and of the carrier 20 may be equal or opposite to each other. The velocities of the carrier 20 and of the mount 30 may be identical or similar to each other. Alternatively and depending on a predefined or pre-programmed reconstitution schedule the angular velocity of the carrier 20 relative to the base 12 and with regard to the first axis of rotation 14 differs from the angular velocity of the mount 30 relative to the carrier 20 with regard to the second axis of rotation 24.

The direction of rotation and/or the angular velocities of the rotational motions of the carrier 20 and of the mount 30, as they are typically induced by the first and the second drives 22, 32 can be individually varied and controlled by the controller 90 in accordance to a predefined reconstitution schedule or reconstitution program.

With an example of a reconstitution program only one of the first and second drives 22, 32 may be active during a first time interval. Thereafter and as a second step, both drives 22, 32 may be activated and may be active during a second period of time. During or after the second period of time, at least one angular velocity of the mount 30 and the carrier 20 may be subject to a stepwise or gradual change.

As further illustrated in FIGS. 9 and 10, the second axis of rotation 24 can be tilted or pivoted with regard to the first axis of rotation 14. Hence, the mount 30 may be pivoted relative to the carrier 20 by means of a second hinge 70. The second hinge 70 as illustrated in FIGS. 1 and 8-10 comprises a second hinge axis 72. The second hinge 70 comprises a second hinge arm 71 that is pivot mounted on the support 80. The second hinge arm 71 provides a support for the rotary bearing 31 of the mount 30. The second hinge arm 71 is fixable or lockable in position relative to the support 80 in any available tilted or pivoted position.

The second hinge axis 72 allows and supports a pivoting or rotation of the mount 30 relative to the carrier 20. By means of the second hinge 70, the mount 30 may be rotated from an upright configuration as illustrated in FIG. 1 to a horizontal orientation, by way of which the second axis of rotation 24 is flipped by 90°. In FIG. 10, an intermediate configuration or orientation of the second axis of rotation 24 is illustrated. Here, the second axis of rotation 24 has been pivoted by about 45° compared to first axis of rotation 14.

With such a tilting, and by arranging the second axis of rotation 24 non-parallel to the first axis of rotation 14 a kind of a shaking motion of the mount 30 and hence of the medicament container 50 can be imitated as the carrier 20 is subject to a continuous rotational movement relative to the base 12. For this, the second drive 32 may be inoperable and may be switched off. The second hinge 70 may provide an arbitrary stepped, discrete or a continuous and hence stepless pivoting or tilting of the mount 30 relative to the carrier 20. In any available orientation or position the second hinge 70 may be fixed, fastened or immobilized so as to maintain the tilted orientation of the mount 30 or medicament container 50 relative to the carrier 20.

Typically, the second hinge axis 72 extends parallel to a planar-shaped upper surface of the carrier 20. The second hinge axis 72 may traverse or cross the second axis of rotation 24. In particular, the second hinge axis 72 may extend perpendicular to the second axis of rotation 24.

In a further configuration as illustrated in FIGS. 4 and 5, also the carrier 20 may be subject to a tilting or pivoting motion relative to the base 12. As illustrated there, the carrier 20 is pivotable relative to the base 12 by the hinge 60 defining the first hinge axis 62. The first hinge axis 62 may also extend parallel to the surface of the planar-shaped carrier 20. The first hinge axis 62 is typically located radially offset from the first axis of rotation 14. The first hinge axis 62 may extend in tangential direction with regard to the first axis of rotation 14.

As it is further illustrated in FIGS. 7-9 the second hinge arm 71 may comprise a somewhat U-shaped contour or shape. The second hinge arm 71 comprises a substantially planar-shaped base portion 66 and a first and a second wing 67, 68 on opposite sides of the base portion 66. The wings 67, 68 protrude substantially perpendicular relative to base portion 66 and downwardly from the base portion 66. The second hinge arm 71 is pivot mounted on the support 80 by the two wings 67, 68. Both wings 67, 68 are intersected by the second hinge axis 72 as illustrated in FIG. 8. At least one of the wings 76 is provided with a slotted link 78. The slotted link 78 is located at a radial distance from the second hinge axis 72.

The slotted link 78 comprises a semi-circular shape with the center axis coinciding with the second hinge axis 72. The slotted link 78 typically comprises a semi-circular shaped groove 73. There is further provided a fastener 76 extending through the slotted link 78 and hence through the groove 73. As shown in FIG. 8, the fastener 76 is engageable with a support element 88 of the support 80. The two wings 67, 68 are pivot mounted on two oppositely located support elements 88 each of which protruding upwardly from an upper surface of the support 80. The fastener 76 may comprise a fastening screw 77. The fastening screw 77 may comprise a wing screw by way of which a pivot motion or inclined position of the mount 30 relative to the carrier 80 with regard to the second hinge axis 72 can be fixed and/or fastened. Releasing of the fastener 76 enables to modify the orientation of the mount 30 relative to the support 80 and/or relative to the carrier 20.

As further illustrated in FIG. 10 one of the wings 68 is provided with a scale 74 on an outside surface. The scale 74 comprises a semicircular shape and thus represents an angular scale. Adjacent to the scale 74 there is provided an indicator 75 on the support element 88. The indicator 75, e.g. comprising a pointed tip, points towards and/or onto the scale 74 and thus indicates the angular position of the hinge 70. In this way, any angular position or inclined orientation of the mount 30 and hence of the second axis of rotation 24 relative to the support 80 can be precisely reproduced. The hinge 70 and hence the second hinge arm 71 can be steplessly and/or continuously pivoted relative to the support 80.

As illustrated in FIG. 4, the first hinge 60 comprises a first hinge arm 61 that is pivotable relative to the base 12 with regard to the hinge axis 62. The first hinge arm 61 is connected to the base 12 through and by the first hinge 60.

In FIGS. 8-10, one example of the mount 30 is shown in a horizontal cross-section through the mount 30 as seen from above. The mount 30 comprises a clamping device 34. The clamping device 34 comprises three fastening elements 36 that may be arranged equidistantly around the outer circumference of the mount 30 or of the tubular shape medicament container 50. The mount 30 comprises a bottom 33 on which, e.g. a tubular-shaped barrel 52 of the medicament container 50 can be positioned. Typically, the barrel 52 is of tubular shape. It comprises a tubular sidewall as illustrated in FIGS. 8-10. The three fastening elements 36 are arranged along the outer circumference and equidistantly along the circumferential direction of the barrel 52. At least one of the fastening elements 36 is provided with a movable fastener 38. Typically, the movable fastener 38 is movable in radial direction with regard to the second axis of rotation 24. It may be slidably mounted in the mount 30. The fastener 38 may comprises a fastening screw 40, e.g. implemented as a wing screw allowing an easy and intuitive handling by the user. The handle section 40 can be moved relative to the mount 30 radially outwardly with regard to the tubular shape of the barrel 52. Optionally, the fastener 38 is mechanically coupled with restoring element, such as a restoring spring operable to urge or to retract the fastener radially inwardly to engage with the barrel 52 of the medicament container 50.

Each one of the fastening elements 36 comprises an abutment body 37 that may protrude radially inwardly from the respective fastening element 36. The abutment body 37 may comprise or may be made of an elastic material, such as an elastomeric material, e.g. a synthetic or natural rubber material. In this way, the barrel 52 of the medicament container 50 can be mechanically fixed and locked to the mount 30 with a friction force sufficient to fasten the medicament container 50 to the mount 30.

In FIGS. 8-10 only one of at least two different configurations for fastening and mounting the medicament container 50 to the mount 30 is illustrated. Here, a bottom 54 of the medicament container 50 is engaged with the bottom 33 of the mount 30 while the outside of the tubular-shaped barrel 52 is in frictional engagement with the fastening elements 37. In another configuration (not illustrated) the bottom 54 of the medicament container 50 abuts in radial direction against one of the fastening elements 36 and the outside of the barrel 52, in particular the outside of the barrel sidewall is in frictional engagement with the other two fastening elements 36. Here, the medicament container 50 is flipped by 90° compared to the configuration as shown in any of the FIGS. 1-10.

In this way and when, e.g. the first hinge 60 has been pivoted by 90° as shown in FIG. 5, such that the first axis of rotation 14 is oriented substantially parallel to the bottom of the base 12 a rotation of the carrier 20 relative to the base may simulate a flipping or twisting of the medicament container 50. With this example as well as with all other examples, the carrier 20 may be pivoted or rotated continuously in one direction or in an alternating fashion, hence in a reversing way.

However, such an orientation of the medicament container 50 may be also obtained with the arrangement of the medicament container 50 in the mount 30 as illustrated in any of the FIGS. 1-3 and when rotating the first hinge 60 by 90° and when rotating the second hinge 70 by 90° as well. Then, the second axis of rotation 24 may extend substantially parallel to the planar-shaped surface of the carrier 20.

In FIG. 6 a flowchart of the method of reconstituting the medicament is briefly illustrated. In step 100 the medicament container is fastened to a mount 30 of the reconstitution device 10 as described above. In a subsequent step 102 the carrier is moved relative to the base.

Concurrently or simultaneously the mount 30 is moved relative to the carrier 20 in step 104. With some examples of the method, the carrier and the mount will be moved by activating respective first and second drives 22, 32. The direction of movement or rotation as well as the velocity and the duration of the movement or rotation can be varied during the reconstitution process in accordance to pre-programmed reconstitution steps or reconstitution sequences. In a final step 106 and after the carrier 20 or mount 30 have been moved relative to the base 12 and/or relative to the carrier 20, respectively, for a predefined period of time, e.g. defined by a predefined reconstitution program, the method and hence the movement of the carrier 20 and/or of the mount 30 will stop in step 106.

### LIST OF REFERENCE NUMBERS

4 top
5 housing
6 bottom
7 front wall
8 side wall
9 back wall
10 reconstitution device
12 base
14 axis of rotation
15 handle
16 fastener
18 stop
20 carrier
21 frame
22 drive
23 handle
24 axis of rotation
26 shaft
28 gearbox
30 mount
31 rotary bearing
32 drive
33 bottom
34 clamping device
36 fastening element
37 abutment body
38 fastener
40 fastening screw
50 medicament container
51 medicament
52 barrel
54 bottom
60 hinge
61 hinge arm
62 hinge axis
63 fastener
64 cam lever
66 base portion
67 wing
68 wing
70 hinge
71 hinge arm
72 hinge axis
73 groove
74 scale
75 indicator
76 fastener
77 fastening screw
78 slotted link
80 support
81 slotted link
82 sliding mechanism
83 groove
84 scale
85 indicator
86 fastener
87 fastening screw
88 support element
90 controller
91 interface
92 wire
94 cable bushing
95 indicator
96 control element
98 control element

1. A reconstitution device for reconstituting a medicament, the reconstitution device comprising:
a base;
a carrier movably arranged on the base;
a mount for a medicament container, wherein the mount is movably arranged on the carrier).

2. The reconstitution device of claim 1, wherein the carrier is rotationally mounted on the base and is rotatable relative to the base with regard to a first axis of rotation.

3. The reconstitution device of claim 1, wherein the mount is rotationally mounted on the carrier and is rotatable relative to the carrier with regard to a second axis of rotation.

4. The reconstitution device of claim 1, wherein the carrier comprises a rotational stage and wherein the mount is arrangeable at numerous positions on the carrier.

5. The reconstitution device of claim 1, wherein the mount is longitudinally displaceable on the carrier.

6. The reconstitution device according to claim 1, further comprising a first drive mechanically engaged with the carrier and configured to move the carrier relative to the base.

7. The reconstitution device according to claim 6, further comprising a second drive mechanically engaged with the mount and configured to move the mount relative to the carrier.

8. The reconstitution device according to claim 1, further comprising a support arranged on the carrier and wherein at least one of the mount and the second drive is arranged on the support.

9. The reconstitution device according to claim 8, wherein the support is longitudinally displaceable relative to the carrier and wherein the support is lockable to the carrier in numerous positional states on the carrier.

10. The reconstitution device according to claim 8, wherein the support is detachably connectable to numerous fastening positions on the carrier being spatially separated from each other.

11. The reconstitution device according to claim 8, wherein a radial distance or radial position of the support on the carrier relative to a first axis of rotation is modifiable.

12. The reconstitution device according to claim 1, further comprising a first hinge connected to the base and connected to the carrier, wherein the first hinge comprises a first hinge axis and wherein the carrier is pivotable relative to the base with regard to the first hinge axis.

13. The reconstitution device according to claim 12, further comprising a second hinge connected to the mount and connected to the carrier, wherein the second hinge comprises a second hinge axis and wherein the mount is pivotable relative to the carrier with regard to the second hinge axis.

14. The reconstitution device according to claim 12, wherein the first hinge axis extends at a non-zero angle with regard to a first axis of rotation.

15. The reconstitution device according to claim 13, wherein the second hinge axis extends at a non-zero angle with regard to a second axis of rotation.

16. The reconstitution device according to claim 1, further comprising a controller operable to control a movement of the carrier relative to the base and/or operable to control a movement of the mount relative to the carrier.

17. The reconstitution device according to claim 1, further comprising a medicament container fastened to the mount.

18. A method of reconstituting a medicament, the method comprising:
fastening a medicament container to a mount of a reconstitution device according to claim 1;
moving the carrier relative to the base; and
moving the mount relative to the carrier.
